(19) United States
(12) Patent Application Publication
(10) Pub. No.: US 2025/0367806 A1
(43) Pub. Date: Dec. 4, 2025

(54) POLYMER PIPE CUTTER WITH SOLVENT CAN OPENER

(71) Applicant: Stetson Development, Inc., Canyon Lake, CA (US)

(72) Inventor: Michael A. STETSON, Canyon Lake, CA (US)

(21) Appl. No.: 19/215,940

(22) Filed: May 22, 2025

Related U.S. Application Data
(60) Provisional application No. 63/653,493, filed on May 30, 2024.

(51) Int. Cl. B25F 1/00; B26D 3/16

(52) U.S. Cl. CPC B25F 1/003; B26D 3/169

(57) ABSTRACT

A gripping system is for use with a pipe cutting tool having a pair of handles and a blade. The gripping system includes an elongate first gripping body configured to be selectively engageable to a first handle to extend along a portion of the first handle. The first gripping body includes a first gripping surface adapted to enhance friction against a lid when the first gripping surface is urged against the lid. An elongate second gripping body is configured to be selectively engageable to a second handle to extend along a portion of the second handle when engaged therewith. The second gripping body includes a second gripping surface adapted to enhance friction against the lid when the second gripping surface is urged against the lid. The gripping bodies are engageable with the handles such that the gripping surfaces are positionable to engage with separate portions of the lid.

### CROSS-REFERENCE TO RELATED APPLICATIONS

This application claims the benefit of U.S. Provisional Application No. 63/653,493, filed on May 30, 2024, and the entire disclosure of which is expressly incorporated herein by reference.

### BACKGROUND

### 1. Technical Field

The present disclosure relates generally to a gripper for opening a twist-lid, and more specifically to a gripping system adapted for use with a polymer pipe cutting tool for opening the twist-lid of a container.

### 2. Description of the Related Art

Irrigation systems typically include polyvinyl chloride (PVC) pipes to transfer water across a property from a main water source to a sprinkler head, drip line, or other water distribution mechanism. Oftentimes, the PVC pipes are sold in long sections that need to be cut to size, and then joined to an adjacent pipe or to the distribution mechanism. Pipe cutting tools are commonly used to cut the pipes for this purpose. A conventional pipe cutting tool typically includes a blade and handles that can be gripped and repeatedly squeezed together. The blade is coupled to the handles such that the repeated squeezing of the handles causes the blade to advance through the pipe to cut the pipe.

Once the pipe is cut, a coupler may be used to join adjacent pipe segments together or to join the pipe to the distribution mechanism. The coupler may be a linear coupler, elbow coupler, T-coupler, Y-coupler, etc. Typically, an adhesive or bonding agent is used to join the pipe to the coupler. The adhesive used in such applications is usually sold in a container having a twist-lid, such that twisting of the lid in a first rotational direction allows for removal of the lid from the main body of the container, and twisting of the lid in a second rotational direction allows for attachment of the lid to the main body of the container.

Over time, the lid may become difficult to remove from the main body of the container for a variety of reasons. One reason may be that when dispensing the adhesive, some adhesive may inadvertently flow to the junction between the lid and the main body. Another reason is that a user may overtighten the lid when closing the lid, thereby making later removal of the lid extremely difficult.

When the lid is difficult to remove, excessive force may be required to remove the lid. If a user attempts to remove the lid in such instances with his hands, the user's hands may become sore or cramped. It is also common to remove the lid with pliers or other tools to enable application of enhanced leverage on the lid. However, some users may not have access to additional tools, or alternatively, may find the use of additional tools tedious.

Accordingly, there is a need in the art for a device that can be used with a pipe cutter to facilitate removal of a twist-off lid. Various aspects of the present disclosure address this particular need, as will be discussed in more detail below.

### BRIEF SUMMARY

Various aspects of the present disclosure are directed toward a gripping system usable with conventional hand-actuated pipe cutting tools for enhancing grip on a twist-off lid. The gripping system may include a pair of gripping bodies attachable to respective handles on the pipe cutting tool to allow the pipe cutting tool to be used in twisting off the lid. As such, the ability of the gripping system to be adaptable for use with the pipe cutting tool may allow the pipe cutting tool to become multi-functional. Therefore, the user may no longer be required to remove the lid directly with the user's hands or require the use of a separate tool.

According to one embodiment, the gripping system is for use with a pipe cutting tool having a pair of handles and a blade, with the handles being transitional between a first position and a second position to actuate the blade against a pipe. The gripping system includes an elongate first gripping body configured to be selectively engageable to a first one of the pair of handles such that the first gripping body extends along a portion of the first one of the pair of handles when engaged therewith. The first gripping body includes a first gripping surface adapted to enhance friction against a lid when the first gripping surface is urged against the lid. The gripping system additionally includes an elongate second gripping body configured to be selectively engageable to a second one of the pair of handles such that the second gripping body extends along a portion of the second one of the pair of handles when engaged therewith. The second gripping body includes a second gripping surface adapted to enhance friction against the lid when the second gripping surface is urged against the lid. The first and second gripping bodies are engageable with the pair of handles such that the first gripping surface and the second gripping surface are positionable to engage with separate portions of the lid.

At least one, or both, of the first and second gripping surfaces may include a plurality of gripping teeth. The plurality of gripping teeth may be arranged in an arcuate configuration.

Both of the first and second gripping surfaces may be formed of a rubber material or a plastic material.

The first and/or second gripping body may be configured to be placeable around a corresponding one of the pair of handles. Each gripping body may extend along a respective longitudinal axis, and include a pair of opposed ends and an opening extending between the pair of opposed ends along the longitudinal axis. The opening may be sized to receive the portion of the corresponding one of the pair of handles. Each gripping body may include a projection extending into the opening and sized to be positioned between a pair of opposed walls of the first one of the pair of handles when the gripping body is engaged with the corresponding one of the pair of handles. Each gripping body may include a gripping portion including the corresponding gripping surface and a handle engagement portion extending from the gripping portion. the gripping portion and handle engagement portion completely circumnavigating the first one of the pair of handles in a cross section perpendicular to the longitudinal axis.

The first and/or second gripping body may be configured to be receivable within a channel formed within the corresponding one of the pair of handles to effectuate engagement with the first one of the pair of handles.

The first and/or second gripping body may include an engagement body configured to be complementary in configuration to the channel formed within the corresponding one of the pair of handles. The first and/or second gripping body may include an abutment shoulder extending from the engagement body and configured to engage with an end surface of the corresponding one of the pair of handles when the gripping body is engaged therewith.

According to another embodiment, there is provided a hand holdable pipe cutting tool adapted for cutting a pipe and removing a lid from a container, the pipe cutting tool includes a blade, and a first handle and a second handle pivotally coupled to each other. The blade is attached to one of the first handle and the second handle. The first handle and the second handle are pivotally transitional between a first position and a second position to actuate the blade against a pipe. The first handle and the second handle include respective inner portions which move toward each other as the first handle and the second handle transition from the first position toward the second position. A first gripping surface is integrally formed along a segment of the inner portion of the first handle, with the first gripping surface being configured to enhance friction against a lid when the first gripping surface is urged against the lid. A second gripping surface is integrally formed along a segment of the inner portion of the second handle, with the second gripping surface being configured to enhance friction against a lid when the second gripping surface is urged against the lid.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a first embodiment of a gripping system for use with a handheld pipe cutter for removing a lid from a container, the gripping system including a pair of gripping bodies attached to the handles of the pipe cutter;

FIG. 2 is a side view of the gripping system of FIG. 1 engaged with a lid (depicted in phantom);

FIG. 3 is an upper perspective view of the gripping body included in the gripping system depicted in FIGS. 1 and 2;

FIG. 4 is a front view of the gripping body depicted in FIG. 3;

FIG. 5 is an end view of the gripping body depicted in FIG. 3;

FIG. 6 is a cross-sectional view taken along line 6-6 of FIG. 2, with the gripping body extending around the handle of the pipe cutting tool;

FIG. 7 is a cross sectional view of another embodiment of a gripping body adapted to be inserted within a channel formed on the handle of the pipe cutting tool;

FIG. 8 is an embodiment of a pipe cutting tool having gripping surfaces formed in the handles of the pipe cutting tool;

FIG. 9 is a side view of another embodiment of a griping system engaged with a lid (depicted in phantom);

FIG. 10 is a perspective view of a gripping body included in the gripping system of FIG. 9; and

FIG. 11 is a front view of the gripping body of FIG. 10.

Common reference numerals are used throughout the drawings and the detailed description to indicate the same elements.

### DETAILED DESCRIPTION

The detailed description set forth below in connection with the appended drawings is intended as a description of certain embodiments of a grip adapted for use on a polymer pipe cutting tool to facilitate opening a lid and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a gripping system that may be used with a handholdable polymer pipe cutting tool to facilitate opening a container, such as a can of solvent. The gripping system may be positioned on the handles of the pipe cutting tool to adapt the handles for use in opening the container. For instance, many containers of solvent include a twist-off lid that opens through rotation of the lid relative to a main body of the container. The gripping system may allow the handles to more effectively grip onto the lid to allow a user to grip the handles of the gripping tool and apply the twisting force to twist the lid relative to the main body of the container. The ability to use the handles of the pipe cutting tool when removing the lid from the container may allow the user to impart greater force on the lid, provide an easier structure to grip (e.g., gripping the handles may be easier than gripping the lid directly), and may minimize pain and discomfort experienced by the user.

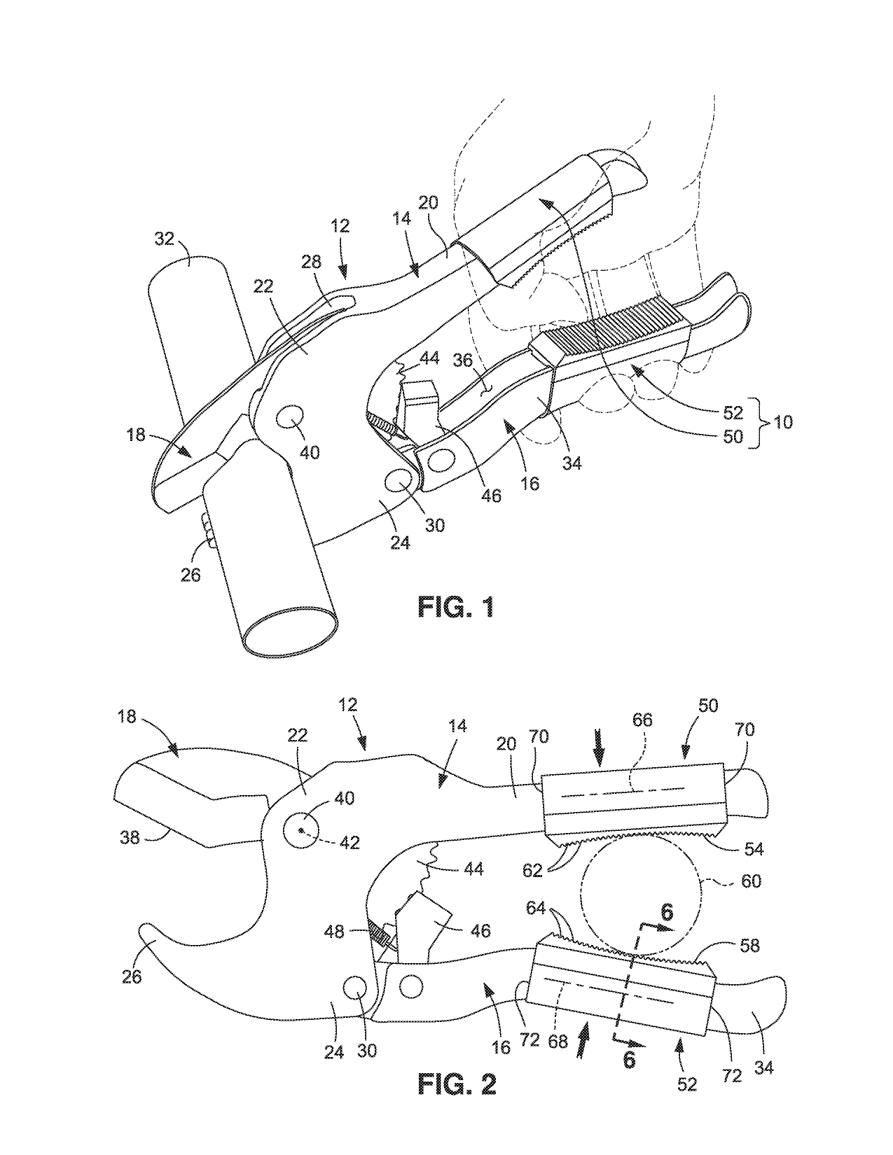

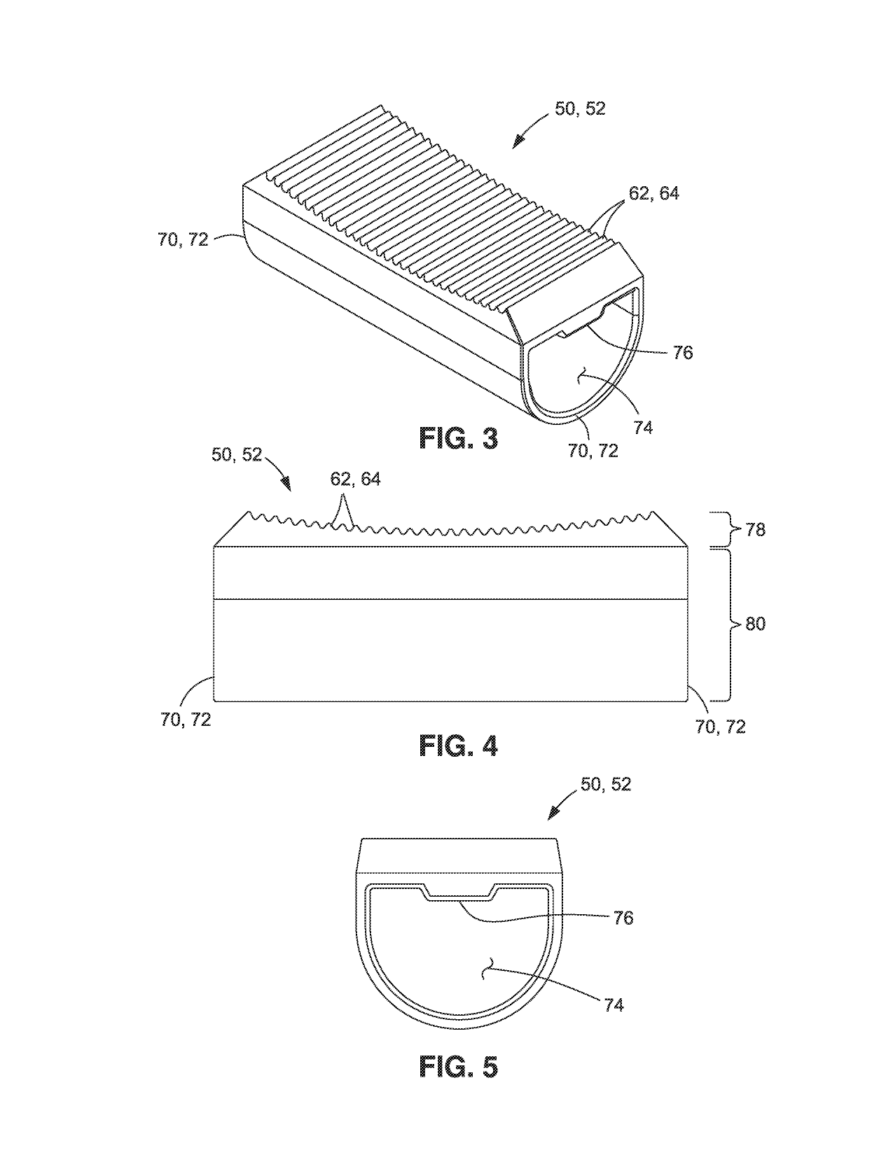

Referring now to the drawings, wherein the showings are for purposes of illustrating preferred aspects of the present disclosure, and are not for purposes of limiting the same, FIGS. 1-6 depict a first embodiment of a gripping system 10 for use with a pipe cutting tool 12. The pipe cutting tool 12 generally includes a first handle 14, a second handle 16, and a blade 18. The first handle 14 includes an elongate hand gripping portion 20, a blade attachment portion 22, a second handle attachment portion 24, and a pipe cradle portion 26. The hand gripping portion 20 may extend from the blade attachment portion 22 in a direction opposite the blade 18. In one embodiment, the hand gripping portion 20 includes a channel extending along the length thereof, and thus, the hand gripping portion 20 may define a generally U-shaped cross sectional configuration. However, it is also contemplated that the hand gripping portion 20 may be formed within a channel, i.e., the hand gripping portion 20 may be solid throughout. The blade attachment portion 22 may include a slot 28 which may accommodate a portion of the blade 18 to allow for attachment of the blade 18 to the first handle 14. The second handle attachment portion 24 may include a protruding structure to which the second handle 16 may be attached. The second handle 16 may be pivotally coupled to the first handle 14 via a rivet, screw, pin, or other mechanical fastener 30. The pipe cradle portion 26 may include a finger-like projection which may help in stabilizing a pipe 32 during cutting. The length of the finger may be greater than the diameter of the pipe 32 that is to be cut. The pipe 32 may be a polyvinyl chloride (PVC) pipe or other pipes commonly cut with a pipe cutting tool.

The second handle 16 may include an elongate hand gripping portion 34 that is pivotally connected to the second handle attachment portion 24 of the first handle 14. The second handle 16 may also include an elongate channel 36 extending along the length thereof, similar to the first handle 14.

The blade 18 is coupled to the first handle 14 and may be configured to move relative to the first handle 14 to effectuate a desired cutting action. In more detail, the blade 18 may include a cutting edge 38 that may be moved closer to the finger-like projection of the pipe cradle portion 26 to cut the pipe 32. The blade 18 may pivot relative to the first handle 14 between an open position and a closed position, with the cutting edge 38 moving toward the finger-like projection as the blade 18 pivots from the open position toward the closed position, and the cutting edge 38 moving away from the finger-like projection as the blade 18 pivots from the closed position toward the open position. The blade 18 may be coupled to the first handle 14 in a manner which allows for such pivotal movement. Fasteners 42 such as a rivet, pin, screw, or the like may be used to connect the blade 18 to the first handle 14, and may define a pivot axis 42 about which the blade 18 may pivot relative to the first handle 14. The blade 18 may additionally include a ratcheting portion 44 having a serrated edge to facilitate stepwise or ratcheting movement of the blade 18. The serrated edge may extend between the first and second handles 14, 16, and may interface with a ratcheting pawl 46 that may be pivotally coupled the second handle 16. The ratcheting pawl 46 may be biased into contact with the serrated edge by a spring 48.

The first and second handles 14, 16 are transitional relative to each other between a first position and a second position to actuate the blade 18 against the pipe 32. The first handle 14 and the second handle 16 having respective inner portions which move toward each other as the first handle 14 and the second handle 16 transition from the first position toward the second position. FIG. 1 shows the pipe cutting tool 10 being used for its originally intended purpose of cutting a pipe 32.

Turning now to the particulars of the gripping system 10, as depicted in FIGS. 1-6, the gripping system 10 includes first and second gripping bodies 50, 52 adapted to be engageable with the first and second handles 14, 16, respectively, by extending around the first and second handles 14, 16. The first gripping body 50 is generally elongate in configuration and configured to extend along a portion of the first handle 14 when engaged therewith. In this regard, the first gripping body 50 may not extend along the entirety of the first handle 14, but only along a portion thereof. The first gripping body 50 includes a first gripping surface 54 adapted to enhance friction against a lid 60 when the first gripping surface 54 is urged against the lid 60, as will be described in more detail below.

The second gripping body 52 may be identical in configuration to the first gripping body 50. In this regard, the second gripping body 52 is generally elongate in configuration and configured to extend along a portion of the second handle 16 when engaged therewith. The second gripping body 52 includes a second gripping surface 58 adapted to enhance friction against the lid 60 when the second gripping surface 58 is urged against the lid 60.

According to one embodiment, the first and second gripping surfaces 54, 58 may include a plurality of gripping teeth 62, 64 adapted to engage with the lid 60. The teeth 62, 64 may extend in a generally side-to-side, parallel configuration. As can be seen from FIG. 4, the plurality of gripping teeth 62, 64 may be arranged in an arcuate configuration to more closely conform to the circular configuration of the lid 60. In particular, the teeth 62, 64 adjacent the ends may be higher than the teeth 62, 64 in the middle, such that the teeth 62, 64 are arranged in a concave configuration. However, it is understood that other configurations of the teeth 62, 64 may be incorporated into the gripping surfaces 54, 58 without departing from the spirit and scope of the present disclosure. For instance, the teeth 62, 64 may be arranged in a generally planar configuration in certain implementations of the gripping surfaces 54, 58. Furthermore, while the exemplary embodiment includes gripping surfaces 54, 58 having a plurality of teeth, it is contemplated that other embodiments may be formed without teeth 62, 64, and instead, may rely solely on the material properties of the gripping surfaces 54, 58 to enhance the grip against a lid 60. For instance, the gripping surface 54, 58 may be formed from a polymer or rubber material that is known for its enhanced fiction with a metal or plastic lid. It is also contemplated that the gripping surfaces 54, 58 may include a coating or may be impregnated with a substance that enhances grip. It is also contemplated that instead of teeth 62, 64, the gripping surfaces 54, 58 may include grooves to form a configuration similar to tire tread to enhance the grip.

As noted above, the first and second gripping bodies 50, 52 may be configured to engaged with the first and second handles 14, 16 via placement of the griping bodies 50, 52 around the handles 14, 16. Each gripping body 14, 16 may include a gripping portion 78 including the gripping surface 54, 58 and a handle engagement portion 80 extending from the gripping portion 78. Each gripping body 14, 16 may also extend along a respective longitudinal axis 66, 68, and may include a pair of opposed ends 70, 72 and an opening 74 extending between the pair of opposed ends 70, 72 along the longitudinal axis 66, 68. The opening 74 may sized to receive the portion of the corresponding first and second handles 14, 16. The gripping bodies 50, 52 may be formed of an elastomeric material which allows the gripping bodies 50, 52 to be stretched to increase the size of the opening 74 to facilitate sliding the gripping bodies 50, 52 over the handles 14, 16. Once the gripping bodies 50, 52 are in the desired location on the corresponding handle 14, 16, the gripping bodies 50, 52 may be released and biased toward their original shape to compress around the handles 14, 16. The gripping portion 78 and handle engagement portion 80 may be sized and configured to completely circumnavigate the corresponding handle 14, 16 in a cross section perpendicular to the respective longitudinal axis 66, 68. The gripping bodies 50, 52 may be positionable on the pair of handles 14, 16 such that the first gripping surface 54 and the second gripping surface 58 are positionable to engage with separate portions of the lid 60. For instance, the first and second gripping surfaces 54, 58 may be on generally opposed sides of the lid 60 (e.g., generally diametrically opposed to one another).

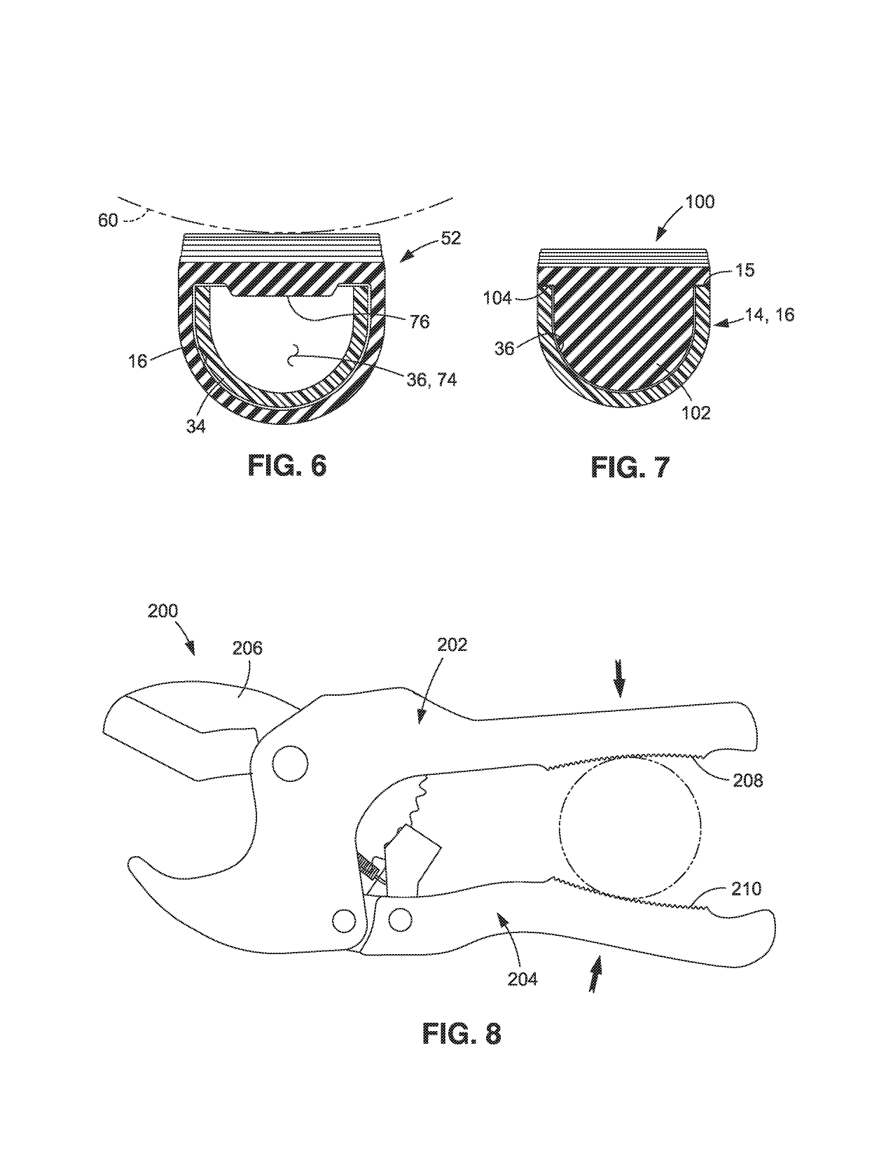

According to one embodiment, and referring specifically to FIGS. 5 and 6, the gripping bodies 50, 52 may include a projection 76 extending into the opening 74 and sized to be positioned between a pair of opposed walls of the corresponding handle 14, 16 when the gripping body 50, 52 is engaged with the handle 14, 16. The projection 76 may help to center the gripping bodies 50, 52 on the handle 14, 16 and maintain the gripping bodies 50, 52 in their desired position on the handle 14, 16 during use. In this regard, the projection 76 may be sized to remain between the opposed walls of the handle 14, 16 during use. The projection 76 may also add some additional material to the portion of the gripping body 50, 52 extending over the channel 36 of the handles 14, 16 to provide added strength and to mitigate undesirable flexion of the gripping body 50, 52.

When the gripping bodies 50, 52 are coupled to the handles 14, 16, the user may grab the handles 14, 16 in the same fashion as when using the pipe cutting tool 10 to cut pipe 32, and urge the gripping bodies 50, 52 against the lid 60 and apply a twisting force to twist the lid 60 off the main portion of the container. The ability to use the handles 14, 16 of the pipe cutting tool 10 as a manual gripping structure may be easier than manually gripping the lid directly. Furthermore, the use of the handles 14, 16 of the pipe cutting tool 10 may allow for greater leverage/force to be applied by the user to more easily remove the lid 60.

While the gripping bodies 50, 52 depicted in FIGS. 1-6 are configured to be engageable with the handles 14, 16 by extending around the handles 14, 16, another embodiments may be configured to be received within the channel 36 of the handles 14, 16. Referring now specifically to FIG. 7, gripping body 100 is shown and includes an engagement body 102 sized to be received within channel 36 of the handles 14, 16. The engagement body 102 may be configured to be complementary in configuration to the channel 36 formed in the handles 14, 16, such that the engagement body 102 may form a friction-tight fit with the handle 14, 16. In certain embodiments, the engagement body 102 may be slightly larger than the channel 36, so as to create a press-fit engagement, wherein insertion of the engagement body 102 into the channel 36 results in the engagement body 102 compressing and applying an outward force against the walls of the handle 14, 16, which enhance the friction therebetween to create a tighter, more secure engagement.

The gripping body 100 includes an abutment shoulder 104 extending from the engagement body 102 and configured to engage with an end surface 15 of the handles 14, 16 when the gripping body 100 is engaged with the handle 14, 16. The abutment shoulder 104 may extend laterally outward and over the end surface 15 of the handles 14, 16 to provide stability to the gripping body 100 during use, and to move effectively distribute forces during use. The abutment shoulder 104 may also provide a stop when the gripping body 100 is being inserted into the channel 36.

The gripping body 100 includes a gripping surface similar to the gripping surfaces 54, 58 discussed above. Therefore, for further discussion regarding the gripping surface, please refer to the above-discussion of the gripping surfaces 54, 58 on gripping bodies 50, 52.

While FIGS. 1-7 show different embodiments of gripping bodies 50, 52, 100 that can be added to conventional pipe cutting tools, FIG. 8 shows an embodiment of a pipecutting tool 200 having a gripping surfaces integrated directly into the handles 202, 204 thereof. In particular, the structure of the pipe cutting tool 200 is similar to the pipe cutting tool 12 discussed above, with the primary distinction being that handle 202 includes gripping surface 208 and handle 204 includes gripping surface 210. The gripping surfaces 208, 210 are formed on the inner portions of the handles 202, 204 (e.g., the portions of the handles that face each other), toward the end of the handles 202, 204 opposite the blade 206. The gripping surfaces 208, 210 may include teeth, grooves, roughened texture, or other grip enhancing features known in the art. The gripping surface 208, 210 may be integrally formed into the handles 202, 204, and may have the attributes discussed above in relation to gripping surfaces 54, 58. Additionally, the gripping surfaces 54, 58 may be knurled or otherwise formed on the handles 14, 16.

The incorporation of the gripping surfaces to the tool, whether the gripping surfaces are added as an aftermarket accessory (e.g., gripping bodies 50, 52, 100), or integrated directly into tool 200, enhances the overall functionality of the pipe cutting tool. The pipe cutting tool may be used, not only to cut pipe, but also to loosen the lid on the can of solvent or adhesive.

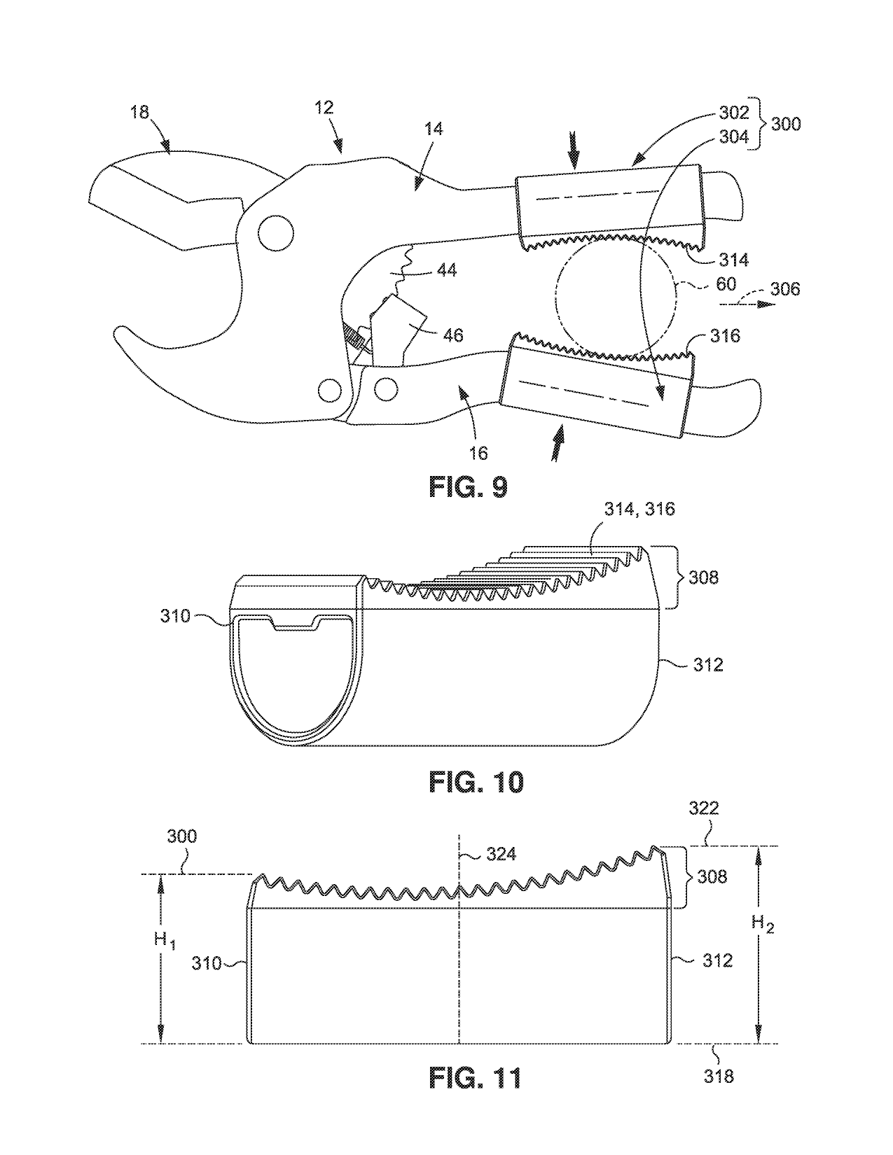

Referring now to FIGS. 9-11, there is depicted another embodiment of a gripping system 300 including gripping bodies 302, 304 specifically configured and adapted to help in retaining the solvent can between the handles 14, 16 of the pipe cutting tool 12, and avoiding slipping out of the opening between the handles 14, 16 in the direction of arrow 306. In this regard, the configuration of the gripping bodies 302, 304 helps to mitigate undesirable movement of the solvent can in the direction of arrow 306. In particular, each gripping body 302, 304 includes a gripping portion 308 that is thicker at one end compared to the other. The thicker end may wrap around the back side of the lid 60 (e.g., the side of the lid 60 positioned opposite the blade 18 of the tool 12) to aid in maintaining a desired position of the lid 60 relative to the handles 14, 16 when the handles 14, 16 are squeezed against the lid 60.

In more detail, each gripping body 302, 304 may include a first end portion 310 and an opposing second end portion 312, with the gripping portion 308 extending between the first and second end portions 310, 312 and having a gripping surface 314, 316 adapted to interface with the lid 60. Each gripping body 302, 304 may also define a reference plane 318 which is tangent to the portion of the gripping body 302, 304 opposite the gripping portion 308. The gripping surface 314, 316 defines a first end plane 320 which is parallel to the reference plane 318, and is at the furthest point of the first end portion 310 along an axis perpendicular to the reference plane 318. The gripping surface 314, 316 also defines a second end plane 322, which is also parallel to the reference plane 318, and is at the furthest point of the second end portion 312 along an axis perpendicular to the reference plane 318. The first end portion 320 defines a first height, H1, as the distance between the first end plane 320 and the reference plane 318, while the second end portion 312 defines a second height, H2, as the distance between the second end plane 322 and the reference plane 318. The second height H2 is greater than the first height H1, which results in the gripping body 302, 304 being asymmetrical about a central axis 324 that is perpendicular to the reference plane 318 and at a midpoint between the first and second end portions 310, 312. In particular, the half of the gripping body 302, 304 including the second end portion 312 may include more volume than the half of the gripping body 302, 304 including the first end portion 310. The thicker second end portion 312 may allow the gripping bodies 302, 304 to more effectively wrap around the lid 60 to prevent the lid 60 from moving in the direction of arrow 306.

While the gripping bodies 302, 304 shown in FIGS. 9-11 are configured to extend around the handles 14, 16, of the pipe cutting tool 12, it is also contemplated that the features of the gripping surfaces having first and second heights may be incorporated into gripping bodies configured to be inserted into the channels 36 formed on the handles 14, 16, similar to the embodiment depicted in FIG. 7.

While the gripping bodies discussed herein are intended for use on a pipe cutting tool, it is contemplated that the gripping bodies may be engageable for use on any tool having opposing, pivotable handles.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A gripping system for use with a lid and a pipe cutting tool having a pair of handles and a blade, the handles being transitional between a first position and a second position to actuate the blade against a pipe, the gripping system comprising:
an elongate first gripping body configured to be selectively engageable to a first one of the pair of handles such that the first gripping body extends along a portion of the first one of the pair of handles when engaged therewith, the first gripping body comprising a first gripping surface adapted to enhance friction against a lid when the first gripping surface is urged against the lid; and
an elongate second gripping body configured to be selectively engageable to a second one of the pair of handles such that the second gripping body extends along a portion of the second one of the pair of handles when engaged therewith, the second gripping body comprising a second gripping surface adapted to enhance friction against the lid when the second gripping surface is urged against the lid;
the first and second gripping bodies being engageable with the pair of handles such that the first gripping surface and the second gripping surface are positionable to engage with separate portions of the lid.

2. The gripping system recited in claim 1, wherein at least one of the first and second gripping surfaces include a plurality of gripping teeth.

3. The gripping system recited in claim 2, wherein the plurality of gripping teeth are arranged in an arcuate configuration.

4. The gripping system recited in claim 1, wherein both of the first and second gripping surfaces include a plurality of gripping teeth.

5. The gripping system recited in claim 1, wherein both of the first and second gripping surfaces are formed of a rubber material or a plastic material.

6. The gripping system recited in claim 1, wherein the first gripping body is configured to be placeable around the first one of the pair of handles.

7. The gripping system recited in claim 6, wherein the first gripping body extends along a longitudinal axis, the first gripping body including a pair of opposed ends and an opening extending between the pair of opposed ends along the longitudinal axis, the opening being sized to receive the portion of the first one of the pair of handles.

8. The gripping system recited in claim 7, wherein the first gripping body includes a projection extending into the opening and sized to be positioned between a pair of opposed walls of the first one of the pair of handles when the first gripping body is engaged with the first one of the pair of handles.

9. The gripping system recited in claim 7, wherein the first gripping body includes gripping portion including the first gripping surface and a handle engagement portion extending from the gripping portion, the gripping portion and handle engagement portion completely circumnavigating the first one of the pair of handles in a cross section perpendicular to the longitudinal axis.

10. The gripping system recited in claim 1, wherein the first gripping body is configured to be receivable within a channel formed within the first one of the pair of handles to effectuate engagement with the first one of the pair of handles.

11. The gripping system recited in claim 1, wherein the first gripping body includes an engagement body configured to be complementary in configuration to the channel formed within the first one of the pair of handles.

12. The gripping system recited in claim 11, wherein the first gripping body includes an abutment shoulder extending from the engagement body and configured to engage with an end surface of the first one of the pair of handles when the first gripping body is engaged with the first one of the pair of handles.

13. A hand holdable pipe cutting tool adapted for cutting a pipe and removing a lid from a container, the pipe cutting tool comprising:
a blade;
a first handle and a second handle pivotally coupled to each other, the blade being attached to one of the first handle and the second handle, the first handle and the second handle being pivotally transitional between a first position and a second position to actuate the blade against a pipe, the first handle and the second handle having respective inner portions which move toward each other as the first handle and the second handle transition from the first position toward the second position;
a first gripping surface integrally formed along a segment of the inner portion of the first handle, the first gripping surface being configured to enhance friction against a lid when the first gripping surface is urged against the lid; and
a second gripping surface integrally formed along a segment of the inner portion of the second handle, the second gripping surface being configured to enhance friction against a lid when the second gripping surface is urged against the lid.

14. The pipe cutting tool recited in claim 13, wherein at least one of the first and second gripping surfaces include a plurality of gripping teeth.

15. The pipe cutting tool recited in claim 14, wherein the plurality of gripping teeth are arranged in an arcuate configuration.

16. The pipe cutting tool recited in claim 13, wherein both of the first and second gripping surfaces include a plurality of gripping teeth.

17. A gripping system for use with a lid and a pipe cutting tool having a pair of handles and a blade, the gripping system comprising:
a first gripping body configured to be selectively engageable to a first one of the pair of handles such that the first gripping body extends along a portion of the first one of the pair of handles when engaged therewith, the first gripping body comprising a first gripping surface adapted to enhance friction against a lid when the first gripping surface is urged against the lid; and
an elongate second gripping body configured to be selectively engageable to a second one of the pair of handles such that the second gripping body extends along a portion of the second one of the pair of handles when engaged therewith, the second gripping body comprising a second gripping surface adapted to enhance friction against the lid when the second gripping surface is urged against the lid.

18. The gripping system recited in claim 17, wherein the first gripping body is configured to be placeable around the first one of the pair of handles.

19. The gripping system recited in claim 18, wherein the first gripping body extends along a longitudinal axis, the first gripping body including a pair of opposed ends and an opening extending between the pair of opposed ends along the longitudinal axis, the opening being sized to receive the portion of the first one of the pair of handles.

20. The gripping system recited in claim 17, wherein the first gripping body is configured to be receivable within a channel formed within the first one of the pair of handles to effectuate engagement with the first one of the pair of handles.
